(19) United States
(12) Patent Application Publication
(10) Pub. No.: US 2014/0272907 A1
(43) Pub. Date: Sep. 18, 2014

(54) METHOD FOR COMMUNICATING AND ASCERTAINING MATERIAL

(71) Applicant: FIRST PRINCIPLES, INC., ALBANY, NY (US)

(72) Inventor: Keith A. Raniere, Clifton Park, NY (US)

(73) Assignee: FIRST PRINCIPLES, INC., ALBANY, NY (US)

(21) Appl. No.: 13/838,481

(22) Filed: Mar. 15, 2013

(51) Int. Cl. G09B 5/00

(52) U.S. Cl. CPC G09B 5/00
USPC 434/362

(57) ABSTRACT

A method for communicating and ascertaining material includes: (a) providing a plurality of assemblages, wherein an assemblage is comprised of a plurality of intelligences; (b) providing an issue and a plurality of material to the plurality of assemblages; (c) communicating and ascertaining the plurality of material between the intelligences of each plurality of assemblage to reach at least one outcome to the issue; (d) reorganizing the plurality of assemblages from a plurality of previous assemblages to a plurality of subsequent assemblages; (e) integrating the at least one outcome of each of the previous assemblages to each of the subsequent assemblages; (f) communicating and ascertaining the plurality of modified material by the intelligences of the plurality of transformed assemblages to reach at least one modified outcome to the issue; and (g) reiterating (d) through (f) until a previous modified outcome of plurality of previous assemblages and a subsequent modified outcome of a plurality of subsequent assemblages are analogous is provided.

### BACKGROUND

1. Field of Technology

The present invention relates to a method for communicating and ascertaining material. In particular, the present invention relates to a method for communicating and ascertaining material within a plurality of assemblages; wherein the assemblages comprise intelligences.

2. Related Art

Methods have been developed attempting to improve the learning performance and comprehensive ability of individuals, especially within a group environment. Such environments have taken many forms; large and small classrooms, internet chat rooms, seminars, conferences, group discussions, public forums, et cetera. Some problems associated with the above methods include an inability to properly present material, communicate issues, lack of participation, passive audience members, social loafing, availability of information, narrow modes of thinking, polarization of viewpoints, and dissemination of misinformation. Current methodologies do not resolve the aforementioned shortcomings. Therefore, there exists a need for a method to communicate and ascertain material within a group environment.

### SUMMARY

The present invention provides a method for communicating and ascertaining material which overcomes the aforementioned deficiencies and, inter alia, provides an intelligence with the ability to determine, analyze, and transform information that is related to the presented issue in a quick, efficient, and profound manner.

The present invention provides a method for communicating and ascertaining material. The method for communicating and ascertaining material, comprising: (a) providing a plurality of assemblages, wherein an assemblage is comprised of a plurality of intelligences; (b) providing an issue and a plurality of material to the plurality of assemblages; (c) communicating and ascertaining said plurality of material between said intelligences of each said plurality of assemblage to reach at least one outcome to said issue; (d) reorganizing the plurality of assemblages from a plurality of previous assemblages to a plurality of subsequent assemblages; (e) integrating the at least one outcome of each of the previous assemblages to each of the subsequent assemblages; (f) communicating and ascertaining the plurality of modified material by the intelligences of the plurality of transformed assemblages to reach at least one modified outcome to said issue; and (g) reiterating steps (d) through (f) until a previous modified outcome of plurality of previous assemblages and a subsequent modified outcome of a plurality of subsequent assemblages are analogous.

### BRIEF DESCRIPTION OF THE DRAWINGS

The features of the present invention will best be understood from a detailed description of the invention and an embodiment thereof. The embodiments herein are selected only for the purpose of illustration and are shown in the accompanying drawings in which:

FIG. 1 illustrates a flow chart of a method for communicating and ascertaining material in accordance with the present invention; and

FIG. 2 illustrates an example of an embodiment of reorganizing assemblages in accordance with the present invention.

### DETAILED DESCRIPTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc. . . . , and are disclosed simply as an example of an embodiment. The features and advantages of the present invention are illustrated in detail in the accompanying drawings, wherein like reference numerals refer to like elements throughout the drawings. Although the drawings are intended to illustrate the present invention, the drawings are not necessarily drawn to scale.

A method for communicating and ascertaining material may comprise: (a) providing a plurality of assemblages, wherein an assemblage is comprised of a plurality of intelligences; (b) providing an issue and a plurality of material to the plurality of assemblages; (c) communicating and ascertaining said plurality of material between said intelligences of each said plurality of assemblage to reach at least one outcome to said issue; (d) reorganizing the plurality of assemblages from a plurality of previous assemblages to a plurality of subsequent assemblages; (e) integrating the at least one outcome of each of the previous assemblages to each of the subsequent assemblages; (f) communicating and ascertaining the plurality of modified material by the intelligences of the plurality of transformed assemblages to reach at least one modified outcome to said issue; and (g) reiterating (d) through (f) until a previous modified outcome of plurality of previous assemblages and a subsequent modified outcome of a plurality of subsequent assemblages are analogous within a preselected number of previous and subsequent assemblages.

FIG. 1 illustrates a flow chart of a method for communicating and ascertaining material 10 comprising steps which may be further discussed in the following paragraphs

A method for communicating and ascertaining material 10 may comprise: (a) providing a plurality of assemblages, wherein an assemblage is comprised of a plurality of intelligences 11. An intelligence, as used herein, may refer to a person, a computer, or another type of thing that may have the capacity for reasoned analysis or perception. Intelligences may have real and individual existence in reality. Examples of intelligences include, but are not limited to: human beings, animals with appreciated brain function, bacteria known to communicate, and artificial intelligence, such as computers, calculators, or any machine or instrument that operates via a central process unit (CPU).

An assemblage, as used herein, may refer to a gathering or a group of two or more intelligences. Mathematically an assemblage (A) may be represented by Eq. 1 below.

A=+I₁+I₂+I₃+ . . . +, 2≦i≦∞ Eq. 1

where I represents a single intelligence.

Examples of assemblages include, but are not limited to: children or adults in a classroom, people attending a seminar or a conference, a family reunion, a trainer with a dolphin in a pool, a pod of whales, two chimpanzees in a cage, a person playing chess against a computer, an orangutan playing chess against a computer, ten computers in a room processing data, four computers participating in a chess tournament, seven computers maintaining and monitoring an electronic perimeter around a miliary installation, or a Petri dish containing one or more types of bacteria.

A plurality of assemblages may include a gathering or a group of two or more assemblages. Mathematically, a plurality of assemblages (PA) may be represented in Eq. 2 below.

PA=A₁+A₂+A₃+ . . . +Aᵢ, 2≦i≦∞ Eq. 2
where A=a single assemblage.
   Examples of a plurality of assemblages include, but are not limited to: a conference with one hundred attendees that are organized into ten assemblages of ten intelligences or twenty assemblages of five intelligences, a classroom of fifty intelligences that are organized into ten assemblages of five intelligences, a discussion group of thirty intelligences organized into five assemblages of six intelligences, etc. . . .

After providing a plurality of assemblages 11, method for communicating and ascertaining material 10 may comprise: (b) providing an issue and a plurality of material to the plurality of assemblages 12. An issue, as used herein, may refer to, for example, a question, a query, an assignment, a project, a matter in dispute, a ranking, a survey, an explanation, or a controversy. Further, providing an issue may comprise assigning a task to at least one of the assemblages of the plurality of assemblages. Material, as used herein, may refer to an idea, observation, timeline, problem, topic, question, subject, argument, statistic, direction, fact, hypothesis, theory, information, a publication, or data. Providing material, as referred to herein, may include, for example, either supplying information to an intelligence or assemblage, or supplying an assemblage with an intelligence that knows, possesses, or otherwise has information. Material may be communicated and ascertained. Examples of material include, but are not limited to: the theory of relativity, various works of literature, the fact that the sky is blue, 81 has a square root, the arguments with respect to the Pro-choice vs. Pro-life debate, the factual history of golf, a school curriculum, a computer programming language, a spreadsheet of data, or the genetic data of DNA.

After providing an issue and material to the plurality of assemblages 12, the method for communicating and ascertaining material 10 may comprise: (c) communicating and ascertaining said plurality of material between said intelligences of each said plurality of assemblage to reach at least one outcome to said issue 13. Communicating, as used herein, may refer to the giving and/or receiving of material. Communication may include, but is not limited to: written communication, oral communication, non-verbal communication, sensory perception, transmitting and receiving electronic signals, and electronic communication. For example, each intelligence of an assemblage may have certain material, and each intelligence may thereby communicate that material to each of the other intelligences within an assemblage. Electronic methods of communication may include the Internet, telephonic communication, wireless/personal data assistants, video recordings, tape recordings, and facsimile.

Ascertaining, as used herein, may refer to the process of making certain, exact, or precise the acquired of knowledge, skill, insight, comprehension, or awareness through study, experience, examination, calculation, deliberation, or contemplation. That is, ascertaining may comprise, for example: analysis, study, examination, calculation, deliberation, debate, comparison, prioritization, ranking, and combinations thereof. An example of ascertaining includes, but is not limited to: gaining insight into the theories of evolution by attending a conference in which experts in the field present current theories of evolution and then attendees break up into smaller groups, debate and deliberate on the theories presented so that, for example, comprehension, awareness of the various alternative theories, and examination of those theories may be undergone, thereby sharpening skills, experience, and contemplation. After the material may be communicated and ascertained, the assemblage may reach at least one outcome to the issue posed or presented.

An outcome, as used herein, may refer to a conclusions, determinations, decisions, settlements, priorities, rankings, answers, and resolutions arrived at by at least one assemblage of a plurality of assemblages. At least one outcome may comprise a resulting response to the at least one issue. Outcomes may typically be given by each assemblage of the plurality of assemblages. Examples of outcomes include, but are not limited to: a list of valuable arguments for each side of a controversy; a hierarchical ranking in a survey or questionnaire; validity of results to scientific experiments; complex mathematical theory solutions; determinations based on group analysis; settlements based upon compromise and negotiation, financial or technical feasibility of events; an alternative dispute resolution solution; and the answer to a finite question.

After an assemblage may reach at least one outcome, the method for communicating and ascertaining material 10 may comprise: (d) reorganizing the plurality of assemblages from a plurality of previous assemblages to a plurality of subsequent assemblages 14. Reorganizing a previous assemblage to a subsequent assemblage may be done, for example, by: (1) receiving at least one subsequent intelligence not part of the previous assemblage and (2) maintaining at least one intelligence from the previous assemblage. It should be noted that intelligences may be added to, subtracted from, swapped into or out of, or remain unchanged from one assemblage to another, of those assemblages participating in the material communicating and ascertaining method 10. This reorganization may be further demonstrated by FIG. 2, which is discussed further below.

FIG. 2 represents an exemplary illustration of the reorganization of a plurality of previous assemblages into a plurality of subsequent assemblages as within the context of the material communicating and ascertaining method 10. A plurality of assemblages may be represented by Previous Groups 30, comprising Group 1 (31), Group 2 (32), and Group 3 (33). Each of the three Previous Groups 30, may be made up of a plurality of intelligences with given material and an issue. For example, Group 1 (31) may comprise A 34, B 35, C 36, and D 37. After communicating and ascertaining said material to reach at least one outcome to said issue 13, the assemblages may be reorganized 14 into Reorganized Groups 60. Reorganized Group 60 may be comprised of various groups, including but not limited to: Group 1′ (61), Group 2′ (62), and Group 3′ (63). An embodiment of reorganization of the assemblages comprises that at least one intelligence remains within an assemblage within the material prior to reorganizing assemblages. For example, given FIG. 2, Group 2 (32) comprises E 42, F 43, G 44, and H 45, whereas after reorganization of assemblages 13, Group 2′ (62) comprises D 37, E 42, 138, and L 41. That is, E 42 was retained from Group 2 (32) to Group 2′ (62). Further, both the original assemblages and reorganized assemblages need not necessarily have equal numbers of intelligences in each group. For example, Original Group 1 (34) has 4 intelligences, while Reorganized Group 1′ (61) and Group 2′ (62) have 5 and 3 intelligences, respectively. After reorganizing assemblages 14, the intelligences of each newly formed subsequent assemblage may then integrate the at least one outcome and further communicate and ascertain the integrated and modified material. The material communicating and ascertaining method 10 may be reiterated 17 as many times as necessary, where at least one intelligence may be retained within each original assemblage.

Again referring to FIG. 1, after an initial assemblage may be reorganized into a subsequent assemblage, the method for communicating and ascertaining material 10 may comprise: (e) integrating the at least one outcome of each of the previous assemblages to each of the subsequent assemblages 15. Integrating may be, for example, incorporating each of the at least one outcome of each previous assemblage into the modified information of each of the subsequent assemblages. The modified information may be, for example, at least one previous assemblage outcome, previous information, intelligence (knowing or possessing) information, and combinations thereof. For example, the integration may take the form of the previous material, which may comprise ideas, possible solutions, and the at least one outcome discovered by the previous assemblage to be propagated to a subsequent assemblage and integrated therein by the retained intelligence. The integration may be, for example, detailing the previous material through written, oral, or electronic form to the other intelligences within the assemblage. This may happen for each of the reorganized assemblages.

After the at least one outcome may have been integrated into the at least one subsequent assemblage, the method for communicating and ascertaining material 10 may comprise: (f) communicating and ascertaining the plurality of modified material by the intelligences of the plurality of transformed assemblages to reach at least one modified outcome to said issue 16. That is, once the integration step may occur, the previous material, previous possible solutions, information, and at least one outcome for one assemblage may be incorporated into the previous material, previous possible solutions, information, and at least one outcome for another assemblage, for one, a few, many, or all of the assemblages that are currently undergoing the material communicating and ascertaining method. The modified material may comprise information. This integrated and recombined end result, along with the material previously provided to the intelligences of each assemblage may be referred to as modified material. Also, it should be noted that even though an assemblage may have reached at least one outcome to the issue presented, that outcome may not be the full outcome, complete answer, multi-dimensional solution, or entire discussion of the issue to halt the method. That is, even if the correct or definitive answer is uncovered, disclosed, selected, or otherwise come upon early on in the process, it may be equally essential, important, or imperative to rule out, prove incorrect, or otherwise exclude any potential outcomes that are incorrect or otherwise not as preferred as the best, right, or most complete outcome. Therefore, once the modified material may be created, then the same communicating and ascertaining steps previously disclosed may be repeated within one or more of the subsequent assemblages. This may be done until an assemblage may reach at least one modified outcome to said issue. A modified outcome, as used herein, may refer to a conclusion, determination, decision, settlement, prioritization, ranking, answer, and/or resolution arrived at by at least one subsequent assemblage of a plurality of subsequent assemblages.

After an assemblage of the plurality of assemblages may reach a modified outcome to the at least one issue presented or posed, the method for communicating and ascertaining material 10 may comprise: (g) reiterating (d) through (f) until a previous modified outcome of plurality of previous assemblages and a subsequent modified outcome of a plurality of subsequent assemblages are analogous 17. Analogous, as referred to herein, may refer outcomes with a resemblance in come particulars. For example, analogous outcomes may refer to a given fraction of the total outcomes as similar or perfect to one another. As another example, analogous may refer to outcomes listing the same arguments on each side of a discussion, or determining a similar prioritization or ranking with respect to the assigned or queried issue.

One embodiment of the present invention includes, but is not limited to, an assemblage within a class environment. In this example of the present invention, the plurality of intelligences may be the students and instructor of the students. The students may be organized into a plurality of assemblages, three groups of four students. The material provided may be an equation, a series of numbers, information, and instructions. The issue may be the task or assignment of proving the Pythagorean Theorem. Each intelligence (student) may then communicate, for example, through written or oral means the material to one another. Then, the intelligences may ascertain the material, for example, by acquiring the numerals to incorporate into the equation, to evaluate the process of incorporation, to contemplate the mathematical implications of the placement of various variables and operation signs, and to calculate a conclusion to the Theorem. The step of communicating and ascertaining material may then result in at least one outcome. The outcome may be the written articulated proof of the Pythagorean Theorem.

Some of the assemblages may have a greater or lesser knowledge of material, analyzing capabilities, or understanding of the issue than other assemblages. The disparity of material, capabilities, and understanding between the assemblages may be due to the fact that some intelligences within a particular assemblage may have more information with respect to the issue than other intelligences. Additionally, some intelligences of a particular assemblage may communicate and ascertain particularly well together, such that they may be able to analyze the given issue on one or more levels, thereby answering the issue more fully and in depth. Even within each assemblage, each intelligence may have a different level of understanding than their fellow assemblage intelligences. This may be a natural result of intelligences having different abilities and attitudes toward the issue, the material provided, the previous material known, as well as the communicating and ascertaining abilities of each intelligence.

The assemblages may then be reorganized into another three assemblages, with each of the assemblages containing four intelligences. However, the reorganization step may conclude such that each assemblage may retain at least one intelligence from the previous group into the subsequent reorganized group. The reorganized assemblages may then continue to analyze and discuss the Pythagorean Theorem through communicating and ascertaining material relevant to the issue. Each reorganized assemblage may then present a modified at least one outcome.

This step may allow for the previous material, which may comprise ideas and possible solutions, discovered by the previous assemblage to be propagated to a subsequent assemblage by the retained intelligence. This may generally be referred to as the integration step. This integration and propagation may occur because the intelligence that remained behind in their previous assemblage as well as the new intelligences entering new assemblages may be able to communicate and ascertain previously discovered ideas and possible solutions. The macro result may be the crosspollination of ideas and possible solutions, carried by intelligences, among all three assemblages. The micro result may be the expansion of knowledge or material, experiences, or reasoning of one or more of the intelligences, which may effectively impart the material communicated and ascertained by a plurality of assemblages on an intelligence.

After the integration, the students (intelligences) may then communicate and ascertain the mass of material that has been modified by the previous discussion into the new discussion containing new assemblages. Further, as previously mentioned, even if an assemblage may have correctly utilized the Pythagorean Theorem to practically conclude the hypotenuse of a triangle, the intelligences may not have mathematically proved the formula, or the intelligences may not appreciate the origins of the Theorem or its potential implications or limitations. The emphasis on all aspects of the issue may be still a further challenge which may direct the intelligences to analyze the issue again but with the view toward ideas and new possibilities that the intelligence or respective assemblage may not have previously addressed in the prior analysis. Therefore, once the modified material may have been created, then the same communicating and ascertaining steps previously disclosed may be repeated within one or more of the subsequent assemblages. This may be done until the a previous assemblage and a subsequent assemblage may reach at least one analogous outcome to said issue. As a result of employing this method and querying the issue with respect to the Pythagorean Theorem, the students (as intelligences within an assemblage) may be able to learn and analyze information more quickly, efficiently, and profoundly to, for example, yield a desired result, correct answer, or proper methodology.

Another embodiment of the present invention includes, but is not limited to, the use of intelligences for data analysis. In this example of one embodiment of the present invention, the intelligences may be computers and the material given may be data collected that is thought to relate to national security. Computers of all types with different computing power are commonly used for data analysis, i.e. speech recognition, data mining, handwriting and face recognition, decision support systems, and problem solving. One can envision a plurality of assemblages of computers for data mining where they could process incredibly large amounts of information to arrive at useful outcomes. An example is the use of computers for data mining and the prediction of terrorist threats by the National Security Agency (NSA).

The NSA is the largest data collecting agency in the world. It collects millions upon millions of pieces of data everyday from all parts of the world. It relies on powerful computers to process and organize the data into useful outcomes relating to threats against the U.S. government. The outcomes are then analyzed by NSA employees and forwarded to the appropriate individuals within the U.S. government. Despite the resources available to the NSA to collect, organize, and analyze data, a huge backlog of unanalyzed data exists due to the shear volume of data archived and collected real time.

A plurality of assemblages of computers could be used to remedy the aforementioned disadvantage. The plurality of assemblages could be made up of five groups of ten supercomputers. The ten supercomputers within each group would collect or be given data collected from around the world. The data could be real time or archived and in the form of, but not limited to, oral communiques, e-mail, pictorial representations, or written letters. The supercomputers within each group would then communicate, ascertain, and analyze the given data using standard artificial intelligence methodology such as heuristic analysis to arrive at outcomes. The supercomputers would be able to communicate among themselves, for example, via LAN, wireless communication, or direct null modem connections in order to come to at least one outcome to said issue, or additionally, to integrate the previous outcomes and material into subsequent assemblages.

The supercomputers then would be reorganized into five groups of ten supercomputers with at least one supercomputer from each of the original five groups remaining with their group. The reorganization does not necessarily require a physical rearrangement of the supercomputers. The supercomputers can simply be directed to communicate with new members of a group, for example, via LAN, wireless communication, or direct null modem connections. The supercomputers within their new groups would share previous analyses and continue analysis of the given data, arriving at more enlightening and profound outcomes.

The steps of reorganizing the supercomputers into new groups (by retaining at least one supercomputer in the original group) and then analyzing and sharing previous analyses to the problem can be reiterated as many times as necessary. As reiteration of the method occurs, the supercomputers, through communicating and ascertaining the material and modified material with respect to the issue posed, may eliminate data that is deemed irrelevant or not applicable to national security and will retain critical data that is. The outcomes arrived at will be more condensed, useful, and accurate then any current data analysis methodology provides.

Another embodiment of the present invention includes but is not limited to the use of intelligences for manipulation of material. In this example of one embodiment of the present invention, the intelligences are bacteria and the material given is genetic material. Cell-to-cell communication among bacteria has become an emergent field of study in microbiology. New research suggests the microbial life is highly social, intricately networked, and teeming with interactions. Researchers have determined that bacteria communicate using molecules comparable to pheromones. Microbes are able to collectively track changes in their environment, conspire with their own species, build mutually beneficial alliances with other types of bacteria, gain advantages over competitors, and communicate with their hosts by this cell-to-cell network.

A plurality of assemblages can be envisioned where bacteria are used to manipulate genetic material. The plurality of assemblages includes five Petri dishes each containing three types of bacteria. The bacteria would be given genetic material. This would be done in accordance with standard methods of delivering genetic material to bacteria. Genetic material could include, but is not limited to, DNA, RNA, mRNA, proteins, or tRNA. The different bacteria types within each group would manipulate the genetic material. After manipulation, the bacteria then would communicate the manipulations performed through the resulting expressions of the genetic material.

The bacteria could be reorganized among the Petri dishes with at least one type of bacteria remaining behind in their original Petri dish. The reorganization step could entail swabbing the Petri dishes to collect specific bacteria types and transferring them to the other Petri dishes. The bacteria types within their new Petri dishes would communicate given genetic material. The steps of reorganizing the bacteria types into new Petri dishes with at least one bacteria type remaining in their original Petri dish, and communicating the genetic material would be reiterated as many times as called for.

Other embodiments of the present invention include, but are not limited to, the teaching and analysis of military strategies where the intelligences can be military personnel, market entry strategies for corporations where the intelligences can be corporate personnel, and new idea generation where the intelligences are computers.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention, as defined by the accompanying claims.

What is claimed is:

1. A method for communicating and ascertaining material comprising:
(a) providing a plurality of assemblages, wherein an assemblage is comprised of a plurality of intelligences;
(b) providing an issue and said material to the plurality of assemblages;
(c) communicating and ascertaining said plurality of material between said intelligences of each said plurality of assemblage to reach at least one outcome to said issue;
(d) reorganizing the plurality of assemblages from a plurality of previous assemblages to a plurality of subsequent assemblages;
(e) integrating the at least one outcome of each of the previous assemblages to each of the subsequent assemblages to arrive at modified material;
(f) communicating and ascertaining the modified material by the intelligences of the plurality of transformed assemblages to reach at least one modified outcome to said issue; and
(g) reiterating (d) through (f) until a previous modified outcome of plurality of previous assemblages and a subsequent modified outcome of a plurality of subsequent assemblages are analogous.

2. The method of claim 1, wherein providing the issue comprises assigning a task.

3. The method of claim 1, wherein providing the material comprises supplying information.

4. The method of claim 1, wherein providing the material comprises supplying the intelligences with information.

5. The method of claim 1, wherein ascertaining comprises one selected from the group consisting of: analysis, study, examination, calculation, deliberation, debate, comparison, prioritization, ranking, and combinations thereof.

6. The method of claim 1, wherein at least one outcome comprises a resulting response to the at least one issue.

7. The method of claim 1, wherein reorganizing the previous assemblage to the subsequent assemblage further comprises:
receiving at least one subsequent intelligence not part of the previous assemblage; and
maintaining at least one intelligence from the previous assemblage.

8. The method of claim 1, wherein integrating comprises incorporating each of the at least one outcome of each previous assemblage into the modified information of each of the subsequent assemblages.

9. The method of claim 8, wherein the modified information is selected from one of the group consisting of: at least one previous assemblage outcome, previous information, at least one intelligence with information, and combinations thereof.

10. The method of claim 1, wherein analogous outcomes further comprises outcomes with a resemblance in some particulars.
